(19) United States
(12) Patent Application Publication
(10) Pub. No.: US 2025/0306544 A1
(43) Pub. Date: Oct. 2, 2025

(54) TRANSFORMER FOR MANUFACTURING DATA

(71) Applicant: Robert Bosch GmbH, Stuttgart (DE)

(72) Inventors: Jared Evans, Sunnyvale, CA (US); Carlos Cunha, Menlo Park, CA (US); Wan-Yi Lin, Wexford, PA (US); Chen Qiu, Pittsburgh, PA (US)

(21) Appl. No.: 18/621,758

(22) Filed: Mar. 29, 2024

(51) Int. Cl. G05B 13/02

(52) U.S. Cl. CPC G05B 13/027

(57) ABSTRACT

A systems and methods for implementing attention-based neural networks, attention modules, regularization techniques, and unique data encoding such as for sequential tabular data and/or manufacturing data is provided. The attention-based neural networks may include a high dropout and unique softmax regularization. The encoding may attend to missing or undefined data as well as numerous data types common to manufacturing data.

### TECHNICAL FIELD

Attention-based neural networks (ABNNs) and transformers to attend to manufacturing data are disclosed. More specifically, an attention architecture to handle sequential tabular manufacturing data is provided.

### BACKGROUND

Machine Learning, foundation models, neural networks such as ABNNs, and/or transformers thereof may be powerful tools to process data and perform a multitude of tasks. Conventionally, they have successfully been applied for natural language processing and vision processing. These conventional applications may draw great success from classification-based task. However, other data processing may pose challenges. For example, common regularization techniques may be problematic for regression-based tasks. Many foundation models include one or more regularization layers within the transformer, which typically enhances stability and hasten training of the model. Particular datasets such as tabular manufacturing data, which is common for manufacturing data may itself pose challenges. Accordingly, improvements in the attending to regression focused applications and/or these kinds of datasets is still needed.

For example, manufacturing generally involves production lines involving a series of sequential processing stations to provide a product of manufacture or saleable product. For example, shaping techniques (e.g., molding, cutting, etc.), joining (e.g., welding, gluing, etc.), coating, and/or packaging may be provided in the same production line. The number of stations may vary greatly depending on the complexity of the product. Further, each station may provide one or more (e.g., a plurality of) measurements such as equipment settings, temperature, dimensions, etc. For example, simple molded plastic products may have only a few stations (e.g., pre-processing, molding, trimming stations) while complex products like vehicles may have hundreds or even thousands of stations to provide a final product or even partial products thereof. The datasets are further complicated because similar but different products (e.g., different vehicles) may be made on the same production line involve different stations and/or involve different procedures at each station. Even when the same station is used vastly different measurements may be obtained for different products.

### SUMMARY

An attention-based neural network architecture is disclosed. In one or more embodiments, the architecture includes an encoder and a transformer. In one or more embodiments, the encoder receives tabular input data including categorical and continuous data types. In various embodiments, the encoder vectorizes and embeds the various data types. In a refinement, the data encoder also applies one or more reduction tensors to provided encoded data sequences such as for the transformer. For example, missing or undefined values may be encoded with sparse representation such that the sequence length is of the data sequences is decreased. In one or more embodiments, the transformer includes a plurality of self-attention layers and at least one cross-attention layer. Each layer may include a plurality of linear layers, multi-head attention, a plurality of dropout functions having high and/or low dropouts, and a non-linear activation. In various embodiments, at least one of the linear layers receives the encoded data sequences from the encoder and passes it to the multi-head attention. In one or more embodiments, the multi-head attention applies a masking function, a softmax function, and applies a high dropout at each head. In a refinement, the high dropout is greater than 0.1.

A method of making a regression-based task is disclosed. The method may include feeding tabular input data to a data encoder to provide encoded input data X₀, feeding the encoded input data X₀ to a stack of self-attention layers to provide a self-attention output X_{N}, feeding the encoded input data X₀ (which may or may not be masked) and the self-attention output X_{N} to a cross-attention layer to provide a final output, and making a regression-based prediction derived from the self-attention output X_{N} and/or final output. In one or more embodiments, the data encoder vectorizes the tabular input data to provide the encoded input data X₀. In various embodiments, each (e.g., self and/or cross) attention layer includes multi-head attention (MHA). In a refinement, parallel linear layers Q, K, and V may be used prior to MHA. In a variation, each head applies a modified softmax function and regression-friendly regularization such as dropout greater than 0.1. In a refinement, X₀ is passed through Q of the cross-attention layer, and X_{N} is passed through K and V of the cross-attention layer to provide the final output.

A non-transitory computer-readable medium having computer-readable instructions stored thereon is also disclosed. The computer-readable instructions may be operable by a processor to normalize a dataset. In one or more embodiments, the instructions are operable to apply multi-head attention with head Q, K, V, each head applying a softmax function with a penalty derived from Lasso regularization (L₁) and Ridge regularization (L₂).

### BRIEF DESCRIPTION OF THE DRAWINGS

FIG. 1 is a schematic showing an embodiment of a learning model architecture.

FIG. 2 is an example of a manufacturing dataset.

FIG. 3 is a schematic showing an embodiment of an attention architecture.

FIG. 4 depicts a representative embodiment of tabular data with undefined values.

FIG. 5 is an encoded right justified representation of the tabular data of FIG. 4 where the undefined values are removed or substituted.

FIG. 6 is a sparse representation of the first data sequence or row of data from FIG. 5.

FIG. 7 is an encoder depicting a method of encoding data such as for a learning architecture.

FIG. 8 is a system to implement the models and methods herein.

FIG. 9 is a computing platform to implement the models and methods herein.

FIG. 10 is a perspective view of an embodiment of a control system.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

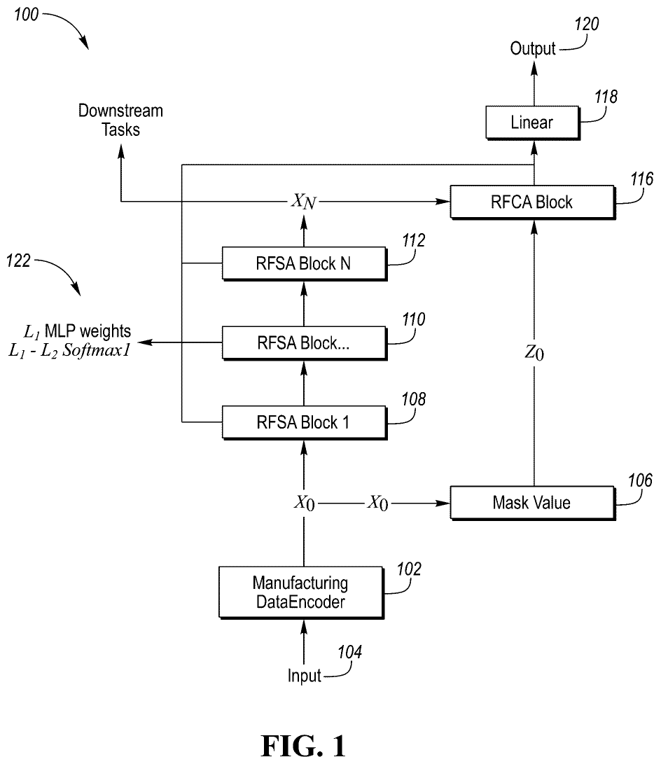

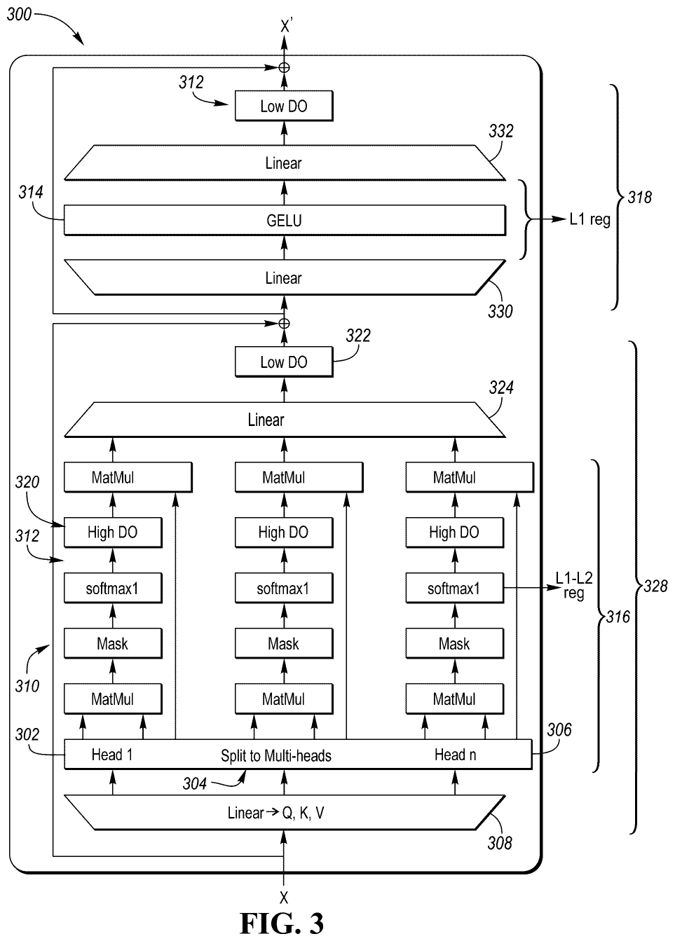

Machine learning models, foundation models, and/or neural networks such as ABNNs for correlating patterns in manufacturing data, as shown in FIGS. 1 and 3 are provided. These models and/or algorithms may be trained to provide insights, efficient decision-making, or improvements for manufacturing processes. Although described herein with a focus on manufacturing data it should be understood that certain components, methods, or models may be applicable to other similar datasets such as but not limited to chemistry, physics, biology, and/or finance and is not necessarily limited to manufacturing. In other embodiments, these models may be particularly suited and useful to manufacturing data and tasks such as scrap reduction, test time reduction, anomaly detection, anomaly prediction, root cause analysis, forecasting, optimization, and/or other tasks.

However, manufacturing data may be particularly difficult to deal with in artificial intelligence models for a number of reasons. Manufacturing datasets may have many diverse value types such as boolean, continuous values, discrete integers, and/or categorical variables. For example, continuous float values may be problematic given conventional regularization techniques such as batch normalization layer (“Layer Normalization,” Jimmy Lei Ba, Jamie Ryan Kiros, and Geoffrey E. Hinton, arXiv preprint arXiv:1607.06450, 21 Jul. 2016) in both halves of the transformer. Prediction-based regression tasks may be detrimentally affected by such regularization techniques. However, merely eliminating batch or layer normalization reduces the generalizability of the model—other regularization techniques such as dropout are necessary and may need to be increased.

Manufacturing data may also be problematic for numerous other reasons. For example, manufacturing datasets may also, or alternatively, be non-gaussian and/or multi-peaked. These datasets often have extreme outliers and are commonly plagued with missing data and/or undefined/invalid data. For example, numerically based manufacturing dataset may include undefined values commonly known as Not-a-Number (NaN). These datasets may have up to 25% of the total values missing or undefined, or even up to 40%, or still even up to 50%. In other words, these datasets may have at least 5% of the values missing or undefined, or at least 10% of the values missing or undefined, or at least 20% of the values missing or undefined, or at least 25% of the values missing or undefined, or at least 30% of the values missing or undefined, or at least 40% of the values missing or undefined, or at least 50% of the values missing or undefined. For example, a manufacturing dataset may have 10 to 90% of its total values missing or undefined, or 20 to 80%, or 30 to 70%. Manufacturing data is also often based on equipment or desired settings. This type of data may be difficult to predict, impute, or estimate as its not necessarily based on the history of the product of manufacture. For example, the height of a drill, software version, or age of equipment/raw materials may be relevant data that is not predictable based on previous data, the product of manufacture, or its prior processing. These types of external properties or measurements may often be referred to as “settings” rather than “result” variables. Conventional neural networks and transformers are not well suited for manufacturing data for at least these reasons as well as numerous other reasons. In yet another example, standard tokenization or standard tokenized corpuses may be inapplicable or inefficient to attend to manufacturing data and common classification-based tasks may be inapplicable or inefficient for manufacturing data.

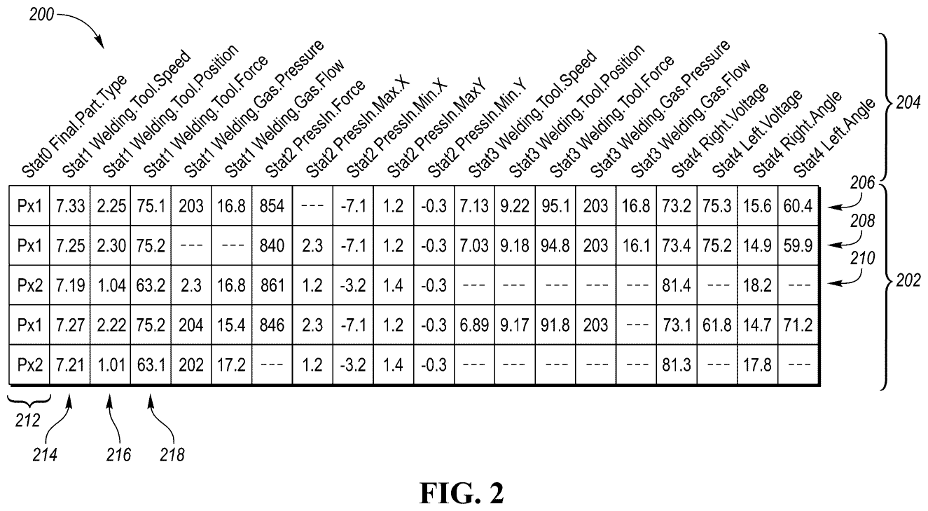

The architectures and methods described herein are particularly designed to ingest, pre-train (e.g., foundational) models, and learn manufacturing correlations through regression task to provide inference or prediction task. These architectures and methods are particularly suited to handle a given table 200 of manufacturing measurements 202 with column identifiers 204 such as names or descriptions and rows 206, 208, 210 associated with specific products 212 such that the remaining data is measurements 202 corresponding to the column identifiers 204 and products 212 such as shown in FIG. 2.

FIG. 1 depicts an attention-based neural network architecture 100 such as for receiving input data 104. In one or more embodiments, the input data 104 is manufacturing data such as sequential tabular manufacturing data as shown in FIG. 2. In a refinement, the input is fed as data sequences where each data sequence is a row comprised of a plurality of columns. The architecture 100 may include an encoder 102 (e.g., to tokenize, vectorize, embed, or otherwise pre-process data), input masking module 106, one or more (e.g., a plurality of) attention blocks 108, 110, 112, 116, and one or more linear block(s) 118 to provide output X_{N} and output 120. In a variation, attention blocks 108, 110, 112 may be a stack of self-attention blocks and/or attention block 116 may be a cross-attention block. In a refinement, the attention blocks 108, 110, 112, 116 may be regression-friendly attention blocks as described herein. For example, regression-friendly self-attention (RFSA) block 300 is shown in FIG. 3. The attention block 300 may also be representative of regression-friendly cross-attention (RFCA) with a few alternations or distinctions as described herein.

In various embodiments, the architecture 100 includes an encoder 102 to receive input data 104 such as (B, S) where B is representative of batch size (e.g., rows) and S is representative of the sequence length (e.g., columns). The encoder 102 may apply a data encoder and reduction tensor to convert the input data 104 to a (B, T, D) tensor X₀, i.e., (B, S)→(B, S, D)→(B, T, D) where D is representative of an embedding dimension and T is representative of reduce sequence length. The tensor X₀ may be passed to input masking module 106 and/or a stack of RFSA blocks 108, 110, 112. In a refinement, the RFSA blocks 108, 110, 112 provide for one or more regularization terms 122 such as a Lasso regularization (L₁) multilayer perceptron (MLP) weight term and/or a lasso-ridge-softmax (e.g., softmax₁) regularization terms such as described herein for contributing to the loss in training. The one or more RFSA blocks 108, 110, 112 may output X_{N}. The input masking module 106 may output masked data Z₀, which is passed to RFCA block 116 and then linear block 118 before yielding a final output 120.

In one or more embodiments, the output X_{N} forms the Key and Value matrices (K and V), and the input/output Z₀ forms the Query matrix (Q) of the RFCA block 116. A mean squared error (MSE) loss is applied to input and output values along with scaled L₁ MLP weight and L₁-L₂ softmax₁ terms to get the training loss. In various embodiments, X_{N} of a trained model can be applied to downstream (regression) tasks.

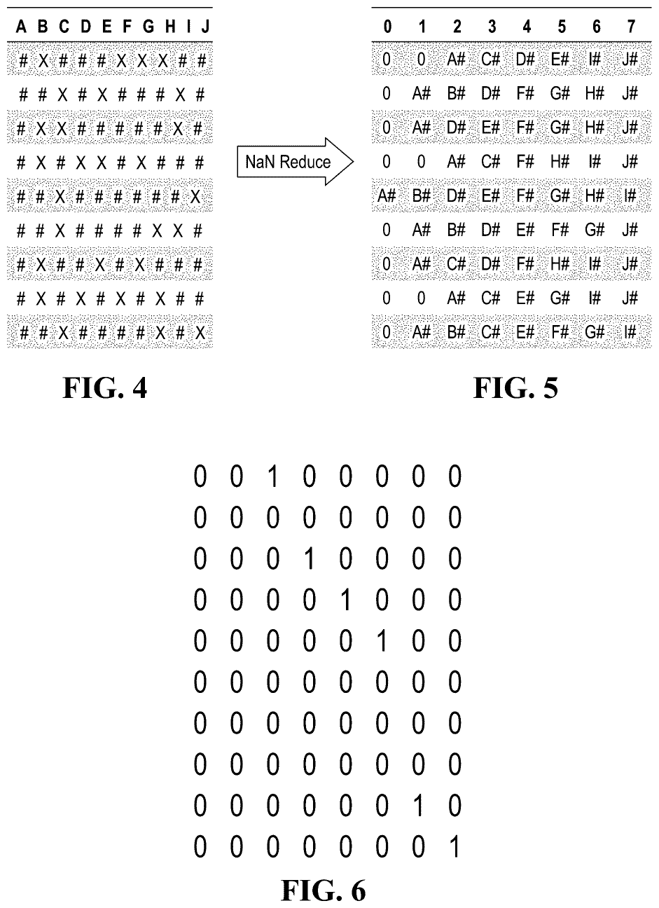

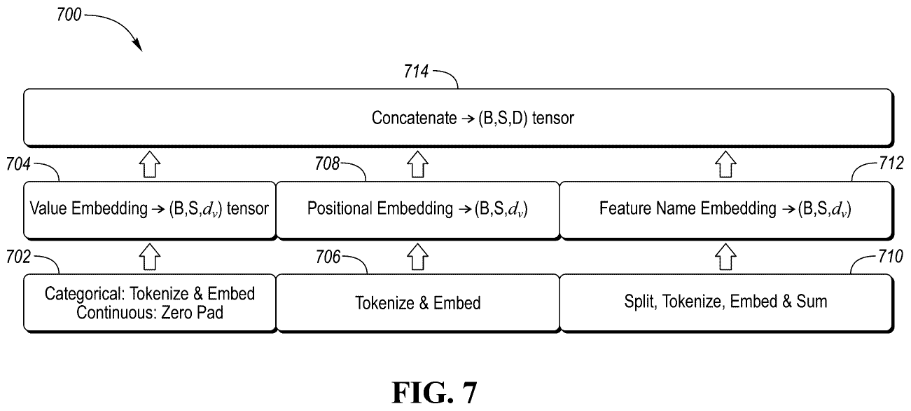

In a refinement, the encoder 102 provides some pre-processing of the data 200 such as shown in FIG. 2. For example, the encoder 102 may include a tabular data encoder as shown in FIG. 7 and/or a reduction mechanism applied through one or more reduction tensors in FIGS. 4-6. In a variation, the data may be tabular data 200, as shown in FIG. 2, having one or more (e.g., a plurality of) rows, e.g., 206, 208, 210 and one or more columns (e.g., a plurality of) columns, e.g., 214, 216, 218. For example, the tabular data 200 may be represented as (B, S) tensor where B is representative of the rows and S is representative of the columns. In various embodiments, each row may correspond to a manufactured product and the columns correspond to different features, properties, settings, and/or measurements of that particular product. In this way, B may be representative of a batch size and S is representative of a sequence length or size. In a refinement, the data 200 may be manufacturing data.

In a refinement, the data 200 may be flattened or otherwise arranged to form a tuple such as {station name}{measurement name}:{result}. The station name and/or measurement name may form a single (S) column of the tabular data. In a variation, a scalar may be applied to the dataset for normalization as it reduces the multi-peak nature of a distribution. For example, the scalar may be applied to each column. In a variation, the scalar is applied over the entire dataset per manufactured component. In a variation, (B, S) is representative of a batch of data where B is the batch size, which corresponds to the number of manufactured components and S sequence length, which corresponds to the number of columns and stations/measurements thereof.

In one or more embodiments, the tabular data may be processed through encoder 102 (e.g., the ManufacturingDataEncoder block). The encoder 102 may vectorize the data or sequences thereof to an embedding dimension D such that a (B, S, D) tensor is provided. In various embodiments, the encoded or vectorized data may also be processed with a reduction method into (B, S, T) and (B, T, D) tensors such that it may be suitable for learning models (e.g., ABNNs and/or attention layers described herein). In a variation, the reduction method removes undefined values such as Not-a-Number (NaN) values from the dataset to provide a refined sequence length (T) that is less than or equal to the original sequence length (S), and more preferably less than (S), i.e., T<S.

In one or more embodiments, the tabular data encoder 700, such as shown in FIG. 7, provides encoding and/or a vectorization such as for sequential (manufacturing) tabular data. In a variation, the tabular data encoder 700 encodes diverse data types (e.g., categorical, integer, float, discrete and/or continuous values) that may be found in tabular datasets. Encoded and vectorized data may be suitable for ingestion by learning models such as neural networks and attention layers such as those found in ABNNs. Encoding generally involves tokenization, vectorization, and embedding.

Tokenization is the process of dividing data sequences, values, or portions thereof into tokens. For example, in natural language processing, a sentence may be tokenized into phrases, words, or even portions of words (e.g., prefix, root word, suffix). Vectorization involves assigning numerical or other computable representations to the tokens. For example, vectorization or vectors may be used to represent tokens. These representations or vectors are used to train learning models, and adapted such that a learned model understands new data, which is the process of embedding. In some modeling such as neural networks these representations may be recognized or referred to as weights.

In various embodiments, the data is encoded or vectorized using various vector fractions or components. In a variation, the vector fractions/components may vary. In a refinement, the vector may be made up of at least two fractions such that at least one (e.g., first) fraction is associated with the continuous value and at least one (e.g., second) fraction is associated with some relational aspect such as positional, locational, naming, etc. In one or more embodiments, the vector fraction is made up of at least three fractions or components. For example, the vector fractions may be weighted such as (¼, ¼, ½).

In one or more embodiments, the first fraction/component (dy) may correspond to the value or table entry (e.g., measurements) such as for value embedding. For example, the value of continuous variable or data (e.g., continuous float values) which are common in, for example, manufacturing data may be zero padded and embedded as the first fraction/component 702. Categorical variables or data may require tokenization of the various categories prior to being embedded 702. However, after tokenization (if necessary) and being embedded further embedding or training 704 is needed. For example, (B, S, dᵥ) may be representative of value embedding. In a refinement, vectorization is based on some learned embedding.

Additional fractions or components to better specify the relational aspects of the data represented may also be included or used although not expressly defined herein. In various embodiments, the embedding dimension D may be characterized by formula (1):

$$D = {d}_{v} + {d}_{i} + … + {d}_{n} \qquad ( 1 )$$

where dᵥ corresponds to value embedding fraction and dᵢ-dₙ correspond to additional relational aspect.

In one or more embodiments, the vector fractions may respectively correspond to the value, position, and a particular feature. For example, the vector (dᵥ, dₚ, d_{f}) comprised of the vector fractions dᵥ, dₚ, d_{f} may be representative of the embedding dimension D as shown below by formula (2):

$$D = {d}_{v} + {d}_{p} + {d}_{f} . \qquad ( 2 )$$

In various embodiments, the vector includes a second fraction/component (dₚ) such as in the vector (dᵥ, dₚ, d_{f}), which corresponds to the position of the data such as for positional embedding. This is relevant and/or important for time-ordered or sequential data, as well as location-specific data. Positional data may also be tokenized prior to vectorizing 706 and embedding 708. In some embodiments, the data is not time ordered such that positional embedding is not necessary. Time ordered data with no specific content for tokenization (e.g., purely numerical data) may be assigned the numerical position thereof and embedded. In various embodiments, (B, S, dₚ) may be representative of positional embedding.

In numerous embodiments, the vector includes a third fraction/component (d_{f}) such as in the vector (dᵥ, dₚ, d_{f}), which is representative of the feature identifier/name and embedded as such. For example, the descriptive name such as for the column may be tokenized and embedded 710. Positional embedding 712 may be represented by (B, S, d_{f}). In a variation, the embedded (feature) vectors are summed to encapsulate the content. In one or more embodiments, the three fractions/components are concatenated 714 together to form the vector (B, S, D), which can then be passed to various machine learning layers or models (e.g., the ABNN) for further processing.

In various embodiments, other embeddable aspects defining how the value should be related and/or understood in context to other values can additionally be included. This can include diverse information such as what is being manufactured, where it is being manufactured, how the data was recorded, or who recorded the data. These additional components may be combined with the others in various fractions to form the (B, S, D) tensor.

In various embodiments, the tabular data such as after being encoded may be processed to remove missing and/or undefined values. For example, a reduction tensor may be used. Many solutions to the pervasive problem of missing or undefined data have been proposed. For example, certain machine learning models can handle missing or undefined data without issue however, the number of models with such capabilities is very limited and these unique models may have other disadvantages. Other alternatives include dropping rows or columns including missing data. However, dropping data results in the loss of a large amount of information. The missing or undefined data may also be substituted with arbitrary values such as statistical values like mean, median, mode, permutative values (e.g., the previous value). This dilutes information and/or can introduce significant bias. Simple predictive techniques such as using regression may be used impute values, however, this to can introduce bias and generally requires high overhead. Another method is representing missing data with categorical variables such as “missing.” Models can then treat the missing data as special. Combinations of these solutions may also be used such as dropping rows with significant missing data while imputing the remaining missing data. It is also problematic to elect any particular solution without understanding why the data is missing or undefined. However, even identifying why may be difficult as production lines are constantly modified and updated. These techniques may also be applicable to numerous datasets that include missing/undefined data such as surveys, personnel data, medical records, and others.

In one or more embodiments, the data may be encoded or reduced to remove missing data or undefined values (e.g., NaN) before feeding to ABNNs or attention layers. In a refinement, the reduction method may include converting each row sequence of the tabular data containing one or more undefined values to a shorter row sequence free of or without any undefined values for processing through the ABNN. This process may be performed as a pre-processing step or in real-time during training/inferencing. The reduction to shorter sequences may improve efficiency or computational throughput.

The encoder 102 may remove and/or substitute undefined values because positional embedding does not occur until after encoding such as tokenization and until such encoded data is provided to the transformer. In one or more embodiments, undefined values are removed by applying a sparse tensor. For example, a batch of manufacturing data, such as in FIG. 4, has a batch size corresponding to its rows/products manufactured (e.g., nine rows), a number of features (e.g., A-J) corresponding to the (e.g., ten) columns which may be represented as S, numerical values represented by #, and undefined values (e.g., NaN values) represented by X. The data defines a sequence length dimension T which may be less than or equal to S depending on the position and number of undefined values. For example, the sequence length T may be represented as 0-7, as shown at the top of FIG. 5, because each row has at least two missing/undefined values (X). In other words, S (e.g., A-J) may be encoded as T. The sequence length is thus decreased, i.e., S=10 while T=8.

The operation to transform the batch of data from (B, S, D)→(B, T, D) may be represented by a sparse (B, S, T) dimension tensor, which may be referred to herein as a reduction tensor. The sparse representations are comprised of 1s and 0s as shown in FIG. 6, which is a sparse representation of the first row of FIG. 5. The sparse representations effectively reduce and right justify the entries of FIG. 4, as shown in FIG. 5. For example, the sparse representation to transform the first data sequence (e.g., first row of FIGS. 4 and 5) is a S×T matrix that may contain no more than a single 1 in each row corresponding to the feature (A-J) disposed in the column corresponding to its position (0-7). For example, the 1 in the first row of FIG. 6 encodes feature A of the first data sequence at position 2. The second row of the sparse representation in FIG. 6 is entirely zeros because feature B of the first data sequence (e.g., first row of FIG. 4 or 5) is not encoded (i.e., it was undefined). The third row of FIG. 6 encodes feature C as at position 3.

This reduction thus removes all undefined values, which can be replaced with placeholder values to avoid numerical issues after the reduction tensor is provided. This method reduces the sequence length from S to T or to the size of the data.

Thus, encoder 102 (e.g., ManufacuringDataEnoder block) may convert the input data 104, as represented by (B, S), to (B, S, D), and then (B, T, D), i.e., (B, S)→(B, S, D)→(B, T, D). In one or more embodiments, this may be achieved in real-time, however, in other embodiments, pre-processing of the data into an intermediate format to more quickly convert it to the (B, T, D) representation may be desirable.

In one or more embodiments, the order of operation described herein should not be understood as limiting. For example, reduction method to address missing/undefined values may be applied prior to tokenization, vectorization, and embedding steps of the encoder 106. In still another embodiment, tokenization may be performed and then the reduction method. In other words, in various embodiments, the order of these steps is not specifically limited to the order described herein and may be altered based on the circumstances. For example, in some instances it may be preferably to tokenize and/or reduce the input data and then store it for faster computing later, which may be particularly relevant when training the models with large datasets that require extensive computational power. However, in other instances, such as during the inference stage, where large training sets are not necessary, real-time encoding may be more preferable.

In various embodiments, the encoded input data (x) is received by the attention block 300, which provides multi-head attention (MHA) 316. In various embodiments, the attention heads may be self-attention and/or cross-attention heads. For example, attention block 300 includes a first head 302, a second head 304, and a nth (third) head 306. In a refinement, the attention block 300 learns or is learned to three weight matrices corresponding to query weights, key weights, and value weights, which may be represented as Q, K, V. In one or more embodiments, input/encoded data (x) is received and passed through one or more (parallel) linear layers 308 as they are split into the different attention heads 302, 304, 306. In a variation, the linear layers 308, 324, 330, and 332 described herein may merely refer to matrix multiplication (MatMul), dense layers, and/or fully connected layers. In various embodiments, the attention block 300 also includes regularizations layers/sublayers 312 and/or activations layers/sublayers 314. For example, the transformer may include a first linear layer 308 before the MHA 316, a second linear layer 324 after the MHA 316, a third linear layer 330 before the activation layer 314, and a fourth linear layer 332 after the activation layer 314. In a refinement, a first low dropout layer 322 is after the third linear layer 330 and a second low dropout layer 312 is after the fourth linear layers 332.

In one or more embodiments, the architectures herein may also provide various masking modules for masking the data. For example, input masking modules 106 may mask input data and/or causal mask may be applied within the transformers/attention layers to mask current, future, and/or past activity. In various embodiments, the encoded data X₀ may be masked by input masking module 106 to provide masked data Z₀ as shown in FIG. 1. In various embodiments, one or more values (e.g., a plurality or all values) may be masked such as by input masking module 106 from X₀ to Z₀. In one or more embodiments, the input masking module 106 removes the continuous numerical values in the value embedding by assigning these values to zero. This serves to create a value-blind representation that is aware of the relational aspects of the data (e.g., position, feature name, etc.), but not of the specific measurement, i.e., what is being measured, but not what the measurement actually is. In refinement, a modified (B, T, D) input tensor may be applied such that X₀ has the corresponding value embedding set to a zero vector Z₀. The (B, T, D) tensor Z₀ may be used to determine only the query value. In one or more embodiments, there may not be an input mask such that X₀=Z₀.

In various embodiments, causal masking layers 310 corresponding to each head 302, 304, 306, may alternatively or more preferably additionally be applied, as shown in FIG. 3. In a variation, causal masking layer 310 may mask against future positions such as in self-attention layers, or mask against concurrent and future positions as in cross-attention layer(s). For example, one or more causal masks M, M′ such as block-sequential causal masks may be used. In a refinement, a first (self-attention) mask M may be provided by creating a number of S×S tensors from the manufacturing data as described herein. The S×S tensors may be created such that ConcurrentStations is defined as time(column i)==time(column j). This creates a block diagonal identity matrix because the stations are time ordered and the function yields TRUE if two measurements are simultaneous and FALSE if two stations are not simultaneous. Combining the ConcurrentStations with a lower triangular true matrix via an ‘OR’ operation provides mask M representative of activity of the current station and all previous stations. This mask may be reduced from S to T by applying the reduction tensor described herein. Finally, treating ‘TRUE’ as zero (0) and ‘FALSE’ as infinity (∞) provides mask M.

A second (cross-attention) mask M′ may be provided in a similar manner as the first (self-attention) mask. However, combining the ConcurrentStations with the lower triangular true matrix is via an ‘AND NOT’ operation instead of the ‘OR’ operation to provide mask M′ representative of activity of all previous stations but not the current station. Thus, when masked input data Z₀ is provided as the cross-attention in the query, the mask M′ will allow for information from the current station to query keys from the past only. Thus, RFCA may predict each measurement corresponding to a column of the sequence from the proceeding station information but without the current station information.

In one or more embodiments, the architecture includes one or more attention blocks 300 to receive input data (x). As described above, this input data (x) may already be encoded and/or masked for attention block 300. For example, manufacturing data 200 such as depicted in FIG. 2 may be flattened, normalized with a scalar to produce dataset (B, S), which is then processed through an encoder such as data encoder 102 to vectorize it to a (B, S, D) tensor and passed through a reduction tensor (B, S, T) to form a sequence length of T<S, as described herein, to produce a (B, T, D) tensor, which is then fed to the attention layers 316, attention block 300, and/or neural network.

In various embodiments, a model may include alternating attention layers 316 and feedforward network 318. In a refinement, feedforward network 318 may include linear layers 308, 324, 330, 332 and activation layers 314. For example, the data may be passed from a preceding attention layer to a first linear layer 330 of the feedforward network 318, followed by an activation layer such as 314 and a second linear layer 332 of the feedforward network 318. In a variation, the attention block(s) may include cross-attention module 116 and/or self-attention modules 108, 110, 112. The cross-attention module 116 and/or self-attention modules 108, 110, 112 may include MHA layers 316. For example, attention modules 316 may pass inputs A and B through linear layers Q, K, and V. For self-attention modules 108 the input A may be equal to the input B (i.e., A=B). In a refinement, attention modules 316 applies a softmax function on QK^{T} as shown by formula (3):

$$Attn ( A , B ) = softmax ( \frac{Q ( B ) \cdot {K ( A )}^{T}}{\sqrt{{d}_{x}}} ) \cdot V ( A ) , \qquad ( 3 )$$

where T is the sequence length of the input sequences, and dx is the dimension for input sequences. In a variation, the multi-head attention module may have a plurality of parallel Q, K, V transform for each layer. In a refinement, the feedforward network 318 includes linear layers 330, 332 with a non-linear activation function such as Gaussian error linear unit (GELU) activation 314. In various embodiments, the cross-attention modules asymmetrically combine two separate sequences such as a first sequence to compute Q and a second sequence to compute K and V. Whereas, the self-attention modules, includes a single sequence for determining, Q, K, and V.

In various embodiments, the self-attention blocks are regression-friendly. For example, one or more of the MHA self-attention blocks include a softmax layer to apply conventional or modified softmax function. Softmax functions regularize data by providing a probability distribution, i.e., within the range of 0 to 1 such that sum adds up to 1. The conventional softmax function is shown below by formula (4):

$$Softmax ( x ) = \frac{{e}^{x}}{\sum {e}^{x}} . \qquad ( 4 )$$

However, this the conventional softmax function may be modified to obtain more accurate or better probability distributions. In a refinement, Softmax₁ is used instead of the conventional softmax function. The Softmax₁ function is shown by formula (5):

$${Softmax}_{1} ( x ) = \frac{{e}^{x}}{1 + \sum {e}^{x}} . \qquad ( 5 )$$

Softmax₁ may improve stability of convergence, generalizability, and interpretability. In a variation, softmax₁ is used to modify one or more attention layers (e.g., is a regularizer for attention layers such as cross-attention and/or self-attention modules). For example, softmax₁ is applied on QK^{T} as shown by formula (6):

$${Softmax}_{1} ( {QK}^{T} ) . \qquad ( 6 )$$

In refinement, the softmax function output may be used as a penalty to the loss term during training. These modified attention layers may mitigate baseline noise that may be associated with conventional attention layers employing typical softmax functions such that precision and interpretability are improved. In other words, the modified attention layers or softmax function decreases the size of small and/or unimportant outputs (e.g., to at least two magnitudes smaller) but the penalty penalizes large, important outputs minimally. In one or more embodiments, the attention layers modified with the softmax₁ function of formula (4) as well as the output penalty may be used in ABNNs which are trained or pretrained on various datasets such as language, image, audio, manufacturing data, time-series and others. In one or more embodiments, softmax₁ may be used with or as an alternative to other regularization techniques such as Lasso regularization (L₁), and/or Ridge regularization (L₂). For example, the Lasso regularization element or penalty is represented by formula (7):

$${L}_{1} = λ {\sum }_{j = 1}^{p} \vert {β}_{j} \vert , \qquad ( 7 )$$

where X is the regularization parameter and β is the coefficient vector. Conventionally, these regularization penalties are applied directly to the layer weights in a neural network. However, in one or more embodiments, β is the output of softmax₁ instead of the model weights. Lasso regularization does very little to this term as it applies a constant pressure on all terms, driving the argument of softmax universally more negative.

In various embodiments, the Ridge regularization element or penalty (L₂) is represented by formula (8):

$${L}_{2} = λ {\sum }_{j = 1}^{p} {β}_{j}^{2} . \qquad ( 8 )$$

Ridge regularization applied to the softmax output may actually perform the opposite of the desired effect and decrease large terms. Inverse Ridge regularization (−L₂) is also ineffective because although −L₂ may provide a similar effect to small or unimportant features it increases or drives up large or important features, which may lead to runaway terms. As opposed to applying L₁ and/or L₂ regularization directly to the weights, we apply an L₁−L₂ penalty to the output of softmax₁(Q·K^{T}) may be beneficial because it drives unimportant features to zero, which mitigates noise that can make interpretability difficult. Other loss techniques may also be applied to the softmax₁ output, in addition to or as an alternative to the L₁ and/or L₂ loss options. Softmax₁ and the regularization techniques described herein provide for a small QK^{T}, which mitigates the challenges associated with settings variable that may be found in manufacturing data. Accordingly, in a refinement, the penalty applied to the softmax (e.g., softmax₁) output is represented by formula (9):

$$Penalty = {L}_{1} - {L}_{2} . \qquad ( 9 )$$

In various embodiments, further regression-friendly regularization such L₁, L₂, weight decay in the optimizer, and/or dropout layers 320 may follow the softmax (e.g., softmax₁) regularization. In a refinement, a high dropout layers 320 are used. In a variation, the high dropout layers 320 are applied at the MHA 316. In a refinement, the dropout (doₐₜₜₙ) may be significantly higher than in conventional models such as large language models where the dropout is typically no more than 0.1. For example, the dropout may be greater than 0.1, or more preferably greater than 0.3, or even more preferably greater than 0.5. For example, the dropout of the high dropout layer 320 may be 0.6. In a refinement, the dropout is 0.1 to 0.8, or more preferably 0.25 to 0.7, or even more preferably 0.55 to 0.65. For example, this modeling may be represented as formula (10):

$$Attn ( Q , K , V , M ) = {DO}_{a t t n} ( {Softmax}_{1} ( \frac{Q . {K}^{T} - M}{\sqrt{{d}_{K}}} ) ) \cdot V . \qquad ( 10 )$$

In one or more embodiments, an additional linear layer 324 and/or dropout layer 322 may follow the MHA 316. In a refinement, the additional dropout layer 322 may be a low dropout layer, i.e., less than the high dropout layer. For example, the dropout (do_{resid}) of the low dropout layer(s) may be less than 0.3, or more preferably less than 0.2 or even more preferably less than or equal to 0.1. In a variation, the bottom (attention) portion 328 of attention block 300 is characterized by formula (11):

$$M H A ( x ) = {DO}_{r e s i d} ( {f}_{l i n} ( {concat}_{j} ( Att n ( {Q}_{j} ( x ) , {K}_{j} ( x ) , {V}_{j} ( x ) , M ) ) ) ) . \qquad ( 11 )$$

In a variation, this is added back to the input of the MHA as a residual. In various embodiments, the feedforward layers 318 may include a multilayer perceptron (MLP) having at least three layers such as linear layers 330, 332 and a nonlinear activation 314. For example, the linear layers 330, 332 may be fully connected neurons and the nonlinear activation 314 may be GELU. The MLP and more particularly the nonlinear activation may distinguish data that is not linearly separable. In refinement, first linear layer 330 may expand the dimension D to a larger dimension such as 4D before passing it through the activation layer 314, and a second subsequent linear layer 332 may contract the larger dimension (4D) back down to D. In various embodiments, another dropout layer such as a low dropout layer is provided after the contraction. The low dropout is less than 0.3, or more preferably less than 0.2 or even more preferably less than or equal to 0.1. For example, the dropout may be 0.1. In one or more embodiments, a lasso (L₁) regularizer may be applied to the weights of the linear layers. In a variation, the dropout is added to the residual as characterized by formula (12):

$$M L P ( y ) = y + {DO}_{r e s i d} ( {f}_{c o n} ( GELU ( {f}_{e x p} ( y ) ) ) , \qquad ( 12 )$$

where y is the output of bottom (attention) portion 328 of attention block 300.

Normalization layers (batchnorm, layernorm, pixelnorm, etc.) may provide important regularizing purposes in neural networks, however, normalization layers may also damage the ability of the network to make precise predictions necessary for regression-based tasks. In one or more embodiments, one or more regression-friendly regularizers may be used, and in a refinement, normalization layers may be excluded. Removing normalization layers may restore precision prediction capabilities but one or more of these regression-friendly regularlizers may be introduced to provide regularization to prevent over-fitting. Regression-friendly regularlizers include L₁/L₂ loss, dropout, optimizer weight decay, data augmentation, noise insertions at various stages, and the L₁−L₂ softmax loss described herein. In a variation, L₁ loss on the MLP layers, weight decay, and high dropout inside the attention blocks and the L₁−L₂ softmax loss are provided to restore a high degree of regularization. In a refinement, one or more of these regularizers may additional or alternatively be used herein.

In one or more embodiments, a (attention-based) neural network architecture 100 includes a stack (e.g., a plurality) of attention blocks such as one or more (e.g., a plurality of) RFSA blocks (e.g., one to five, or more preferably two to four, or even more preferably three). Each RFSA block may for example be represented by FIG. 3 and represented as formula (13):

$${x}_{i + 1} = RFSA {Block}_{i} ( {x}_{i} ) = M L P ( {x}_{i} + M H A ( {x}_{i} ) ) . \qquad ( 13 )$$

In various embodiments, the architecture 100 also include one or more RFCA. In a refinement, a single RFCA block is included. In one or more embodiments, RFCA blocks may differ from the RFSA blocks in that X_{N} is provided for the Key and Value matrices K and V of the RFCA block, while Q is provided by Z₀, which is achieved by zeroed value embedding. In a refinement, the mask applied to each attention block (e.g., the RFSA and RFCA) is different. For example, the RFCA block may mask the block diagonal entries while the RFSA blocks do not, i.e., RFSA applies mask M and RFCA applies mask M′. In various embodiments, the causal mask for the RFCA block additionally masks concurrent information.

In one or more embodiments, the output of the RFCA block may be passed through a linear layer such as to convert (B, T, D) to (B, T, 1). This prediction may be compared with the original input value to calculate an MSE loss. In various embodiments, a soft loss clipping may be applied to mitigation distortion by extreme outliers. In a refinement the soft loss clipping may operate by identifying an absolute maximum value such that all values exceeding the absolute maximum value are scaled down. In various embodiments, this is applied to the MSE loss on a per prediction basis.

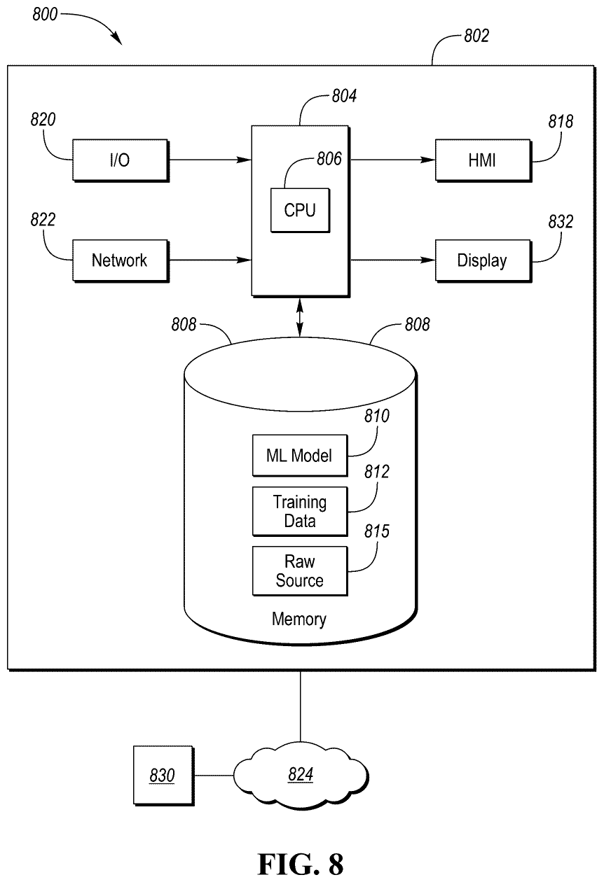

FIG. 8 shows system 800 that may be used for training and/or operating one or more foundation models, ABNNs, transformers, attention modules, encoders, and/or other components or techniques described herein. The system 800 may include at least one computing system and/or device 802. The computing system 802 may include at least one processor 804 that is operatively connected to a memory unit 808. The processor 804 may be one or more integrated circuits that implement the functionality of a central processing unit (CPU) 806. Alternatively, the processor 804 may be designed to implement the functionality of a graphic processing unit (GPU). The CPU 806 may be a commercially available processing unit that implements an instruction set such as one of the x86, ARM, Power, or MIPS instruction set families.

During operation, the CPU 806 may execute stored computer readable/machine/program instructions that are retrieved from the memory unit 808. The stored computer readable/machine/program instructions may include software that controls operation of the CPU 806 to perform the operation described herein. In some examples, the processor 804 may be a system on a chip (SoC) that integrates functionality of the CPU 806, the memory unit 808, a network interface, and input/output interfaces into a single integrated device. The computing system 802 may implement an operating system for managing various aspects of the operation.

The memory unit 808 may include volatile memory and non-volatile memory for storing instructions and data. The non-volatile memory may include solid-state memories, such as NAND flash memory, magnetic and optical storage media, or any other suitable data storage device that retains data when the computing system 802 is deactivated or loses electrical power. The volatile memory may include static and dynamic random-access memory (RAM) that stores computer readable/machine/program instructions and data. For example, the memory unit 808 may store a machine-learning model 810 or algorithm, training dataset 812 for the machine-learning model 810, and/or raw source data 815.

The computing system 802 may include a network interface device 822 that is configured to provide communication with external systems and devices. For example, the network interface device 822 may include a wired and/or wireless Ethernet interface as defined by Institute of Electrical and Electronics Engineers (IEEE) 802.11 family of standards. The network interface device 822 may include a cellular communication interface for communicating with a cellular network (e.g., 3G, 4G, 5G). The network interface device 822 may be further configured to provide a communication interface to an external network 824 or cloud.

The external network 824 may be referred to as the world-wide web or the Internet. The external network 824 may establish a standard communication protocol between computing devices. The external network 824 may allow information and data to be easily exchanged between computing devices and networks. One or more servers 830 may be in communication with the external network 824.

The computing system 802 may include an input/output (I/O) interface 820 that may be configured to provide digital and/or analog inputs and outputs. The I/O interface 820 may include additional serial interfaces for communicating with external devices. For instance, the I/O interface 820 may be configured to receive data from sensors that provide sensed signals.

The computing system 802 may include a human-machine interface (HMI) device 818 that may include any device that enables the system 800 to receive control input. Examples of input devices may include human interface inputs such as keyboards, mice, touchscreens, voice input devices, and other similar devices. The computing system 802 may include a display device 832. The computing system 802 may include hardware and software for outputting graphics and text information to the display device 832. The display device 832 may include an electronic display screen, projector, printer or other suitable device for displaying information to a user or operator. The computing system 802 may be further configured to allow interaction with remote HMI and remote display devices via the network interface device 822.

The system 800 may be implemented using one or multiple computing systems. While the example depicts a single computing system 802 that implements all of the described features, it is intended that various features and functions may be separated and implemented by multiple computing units in communication with one another. The particular system architecture selected may depend on a variety of factors.

The system 800 may implement a machine-learning algorithm 810 that is configured to analyze the raw source data 815 (or dataset). The raw source data 815 may include an input dataset for a machine-learning system. In one or more embodiments, raw or unprocessed sensor data that may be representative of input dataset. In some examples, the machine-learning algorithm 810 may be a neural network algorithm (i.e., ABNN) that may be designed to perform a predetermined function. For instance, the neural network may be employed in conjunction with the embodiments described herein.

The system 800 may store a training dataset 812 for the machine-learning algorithm 810. The training dataset 812 may represent a set of previously constructed data for training the machine-learning algorithm 810. The training dataset 812 may be used by a machine-learning algorithm 810 to learn weighting factors associated with a machine learning algorithm. The training dataset 812 may include a set of source data that has corresponding outcomes or results that the machine-learning algorithm 810 tries to duplicate via the learning process.

In one or more embodiments, these models may be embodied in algorithms such as on non-transitory computer-readable mediums that may be provided in one or more computing platforms or devices such as shown in FIG. 8.

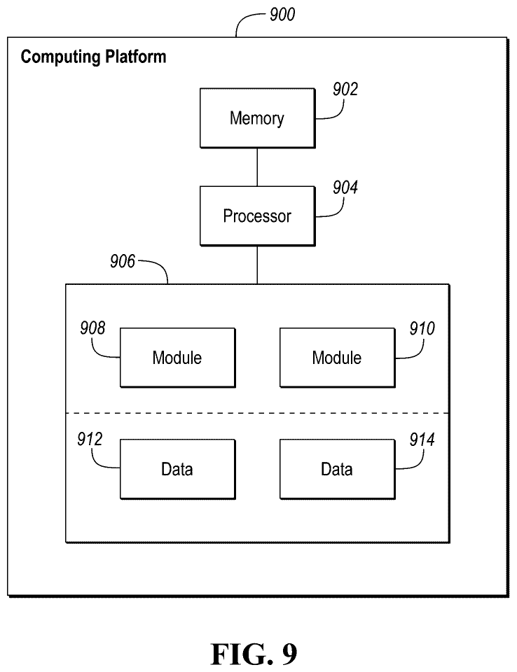

A computing platform, such as the computing platform 900 as illustrated in FIG. 9 may be used to implement the models and/or methods described herein. The models and/or methods described herein may be implemented as part of a computational software suite. The computing platform 900 may include memory 902, processor 904, and non-volatile storage 906. The processor 904 may include one or more devices selected from high-performance computing (HPC) facilities including high-performance cores, microprocessors, micro-controllers, digital signal processors, microcomputers, central processing units, graphical processing units, tensor processing units, field programmable gate arrays, programmable logic devices, state machines, logic circuits, analog circuits, digital circuits, or any other devices that manipulate signals (analog or digital) based on computer-executable instructions residing in memory 902. A HPC facility may include advanced computing hardware and software configured to perform computationally intensive tasks at much higher speeds than a typical desktop or server computer. The HPC facility may deliver up to one (1) million random read input/output operations per second (IOPS).

Memory 902 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information. The non-volatile storage 906 may include one or more persistent data storage devices such as a hard drive, optical drive, tape drive, non-volatile solid state device, cloud storage or any other device capable of persistently storing information.

Processor 904 may be configured to read into memory 902 and execute computer-executable instructions residing in software modules 908 and 910 of the non-volatile storage 906 and embodying models and/or methods of one or more embodiments. Software modules 908 and 910 may include operating systems and applications. Software modules 908 and 910 may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by the processor 904, the computer-executable instructions of software modules 908 and 910 may cause the computing platform 900 to implement one or more of the models and/or methods of one or more embodiments disclosed herein. The non-volatile storage 906 may also include data 912 and 914 supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

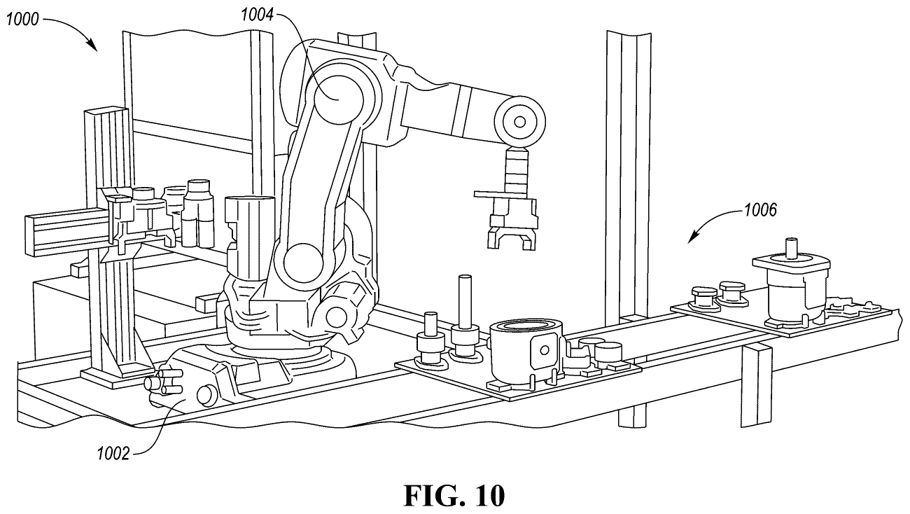

Control systems of one or more embodiments may be configured to provide output such as manufacturing data output or other data output from the machine learning system. This output or inferences generated therefrom may serve as actuation signal(s) or initiate transmission of actuation signal(s) for controlling or actuating a device (e.g., robot, robotic arm, or device on an assembly line). Shown in FIG. 10 is an embodiment of a system 1000 in which control system 1002 is used for controlling robotic arm 1004 of assembly line 1006 such as including one or more station (e.g., a plurality of stations) along a conveyor. In one or more embodiments, the stations may include various sensors to obtain data/measurements. Control system 1002 may be configured to determine or ascertain an actuation signal from the manufacturing data output or other data output by the machine learning systems of one or more embodiments. The actuation signal may be used to control robotic arm 1004. The actuation signal may be supplied or transmitted to robotic arm 1004. The robotic arm 1004 may be activated and controlled using the actuation signal. For example, the robotic arm 1004 may include one or more actuators to accommodate movement and the actuation signal may control the one or more actuators.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “substantially,” “generally,” or “about” means that the amount or value in question may be the specific value designated or some other value in its neighborhood. Generally, the term “about” denoting a certain value is intended to denote a range within +/−5% of the value. As one example, the phrase “about 100” denotes a range of 100 +/−5, i.e. the range from 95 to 105. Generally, when the term “about” is used, it can be expected that similar results or effects according to the invention can be obtained within a range of +/−5% of the indicated value. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4, . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits. Similarly, whenever listing integers are provided herein, it should also be appreciated that the listing of integers explicitly includes ranges of any two integers within the listing.

As used herein, the term “and/or” means that either all or only one of the elements of said group may be present. For example, “A and/or B” means “only A, or only B, or both A and B”. In the case of “only A”, the term also covers the possibility that B is absent, i.e. “only A, but not B”. It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

The term “comprising” is synonymous with “including,” “having,” “containing,” or “characterized by.” These terms are inclusive and open-ended and do not exclude additional, unrecited elements or method steps. The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole. The phrase “consisting essentially of” limits the scope of a claim to the specified materials or steps, plus those that do not materially affect the basic and novel characteristic(s) of the claimed subject matter. The term “one or more” means “at least one” and the term “at least one” means “one or more.” The terms “one or more” and “at least one” include “plurality” as a subset.

The description of a group or class of materials as suitable for a given purpose in connection with one or more embodiments implies that mixtures of any two or more of the members of the group or class are suitable. Description of constituents in chemical terms refers to the constituents at the time of addition to any combination specified in the description and does not necessarily preclude chemical interactions among constituents of the mixture once mixed. First definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method of analyzing manufacturing data, the method comprising:
receiving tabular input data including categorical and continuous data types, at an encoder to vectorize, embed, and apply a reduction tensor to the tabular input data to provided encoded data sequences; and
passing the encoded data sequences to a plurality of self-attention layers and at least one cross-attention layer to provide an output, the plurality self-attention layers and the at least one cross-attention layer each including a plurality of linear layers, multi-head attention, a plurality of low dropout functions, and a non-linear activation, at least one of the plurality of linear layers arranged to receive the encoded data sequences and pass the data to the multi-head attention, the multi-head attention applying a masking function, a softmax function, and a high dropout at each head, the high dropout being greater than 0.1 and greater than dropout of the plurality of low dropout functions.

2. The method of claim 1, wherein the transformer does not include a batch normalization layer or layer normalization layer.

3. The method of claim 1, wherein the softmax function is represented by formula (5):
$${Softmax}_{1} ( x ) = \frac{{e}^{x}}{1 + \sum {e}^{x}} . \qquad ( 5 )$$

4. The method of claim 1, wherein the high dropout is greater than 0.3.

5. The method of claim 1, wherein the high dropout is greater than 0.5.

6. The method of claim 1, further comprising determining an actuation signal from the output, and controlling an actuator using the actuation signal.

7. The method of claim 1, wherein the one or more of the plurality of linear layers and the non-linear activation form a multilayer perceptron where an Lasso regularization element is applied.

8. The method of claim 1, wherein a penalty is applied to an output of the softmax function.

9. The method of claim 1, wherein multi-head attention is represented by formula (10):
$$Attn ( Q , K , V , M ) = {DO}_{a t t n} ( {Softmax}_{1} ( \frac{Q . {K}^{T} - M}{\sqrt{{d}_{K}}} ) ) \cdot V , \qquad ( 10 )$$
where Q is a query matrix, K is a key matrix, v is a value matrix, and M is a mask, T is a sequence length, and d_{K} is a dimension of K, and softmax₁ is represented by formula (5):
$${Softmax}_{1} ( x ) = \frac{{e}^{x}}{1 + \sum {e}^{x}} . \qquad ( 5 )$$

10. A method of making a regression-based task, the method comprising:
feeding tabular input data to a data encoder, the data encoder vectorizing the tabular input data to provide encoded input data X₀;
feeding the encoded input data X₀ to a stack of self-attention layers, each self-attention layer having multi-head attention with heads corresponding to linear layers Q, K, V, each head applying a modified softmax function and a dropout of greater than 0.1, the stack of self-attention layers providing a self-attention output X_{N};
feeding the encoded input data X₀ through an input masking module to provide an output Z₀;
feeding Z₀ and the self-attention output X_{N} to a cross-attention layer, the cross-attention layer having multi-head attention with heads corresponding to linear layers Q, K, V, each head applying a modified softmax function and a dropout of greater than 0.1, where X₀ is passed through Q of the cross-attention layer, and X_{N} is passed through K and V of the cross-attention layer to provide a final output; and
making a regression-based prediction derived from the self-attention output X_{N} and/or the final output.

11. The method of claim 10, wherein the tabular input data is manufacturing data.

12. The method of claim 10, wherein the data encoder applies a reduction tensor to remove undefined values from the tabular input data.

13. The method of claim 10, wherein each attention layer includes a gaussian error linear unit.

14. The method of claim 10, wherein the modified softmax function is represented by formula (5):
$${Softmax}_{1} ( x ) = \frac{{e}^{x}}{1 + \sum {e}^{x}} . \qquad ( 5 )$$

15. The method of claim 10, wherein a mask M is applied to represent all activity of current manufacturing stations and all activity of previous manufacturing stations.

16. The method of claim 10, wherein first masks are applied via the stack of self-attention layers and a second mask is applied via the cross-attention layer, the first masks being different from the second mask.

17. The method of claim 10, wherein a L₁-L₂ penalty is applied to an output of the modified softmax function.

18. A non-transitory computer-readable medium having computer-readable instructions stored thereon, the computer-readable instructions operable by a processor to normalize a dataset, the instructions operable to perform functions of:
apply multi-head attention with heads corresponding to linear layers Q, K, V, each head applying a softmax function to provide a softmax output, applying a penalty to the softmax output, and applying further regularization after applying the softmax function.

19. The non-transitory computer readable medium of claim 18, wherein the softmax function is represented by formula (5):
$${Softmax}_{1} ( x ) = \frac{{e}^{x}}{1 + \sum {e}^{x}} . \qquad ( 5 )$$

20. The non-transitory computer readable medium of claim 18, wherein the further regularization is a dropout of greater than 0.3.
